(19) United States
(12) Patent Application Publication
(10) Pub. No.: US 2004/0231103 A1
(43) Pub. Date: Nov. 25, 2004

(54) Workhorse AKA magnum hinge pin replacement

(76) Inventor: Wayne Alan Magnuson, Shaunavon (CA)

Correspondence Address: WAYNE A. MAGNUSON, BOX 1285, SHAUNAVON, SK, S0N 2M0, CA

(21) Appl. No.: 10/345,860

(22) Filed: May 19, 2003

(51) Int. Cl. E05D 11/08

(52) U.S. Cl. 16/340

(57) ABSTRACT

A vehicle door assembly according to this invention has a hinge bracket for mounting on each of a door and body pillar of a vehicle. Each hinge bracket has a pair of spaced-apart legs wherein the pair of legs of one hinge bracket is received within and adjacent to the pair of spaced-apart legs of the other bracket when the hinge brackets are hingedly mated together. The hinge brackets have aligned holes formed through their respective pair of legs through which the hinge pins are received and secured to hingedly mate the two hinge brackets together. The improvement comprises that specifically machined, stainless steel hinge pins having, threaded tips or ends be installed in the, OEM hinge bracket holes and, with the use of a threaded locking nut, be pulled & secured into their respective places to hingedly mate these two hinge brackets together.

The ‘MAGNUM HINGE PIN REPLACEMENT’ is an improved hinge pin and retention invention of a vehicle hinge assembly. This invention specifically targets the door hinge assemblies for GENERAL MOTORS/CHEVROLET 1999-2003 ck1500/2500 series pick ups.

### BACKGROUND OF THE INVENTION

Vehicle door hinge assemblies conventionally are comprised of two brackets. One is attached to the body pillar, and the other attached to the door shell. Each bracket has a pair of legs, or hinge leafs. One bracket is an outer bracket and the other an inner bracket, wherein the pair of legs of the inner bracket is received within, and adjacent to the pair of outer leg brackets. The two bracket are hingedly mated together by hinge pins which extend through vertically aligned holes formed in the legs of these brackets.

One vehicle in particular uses this hinge assembly style. The problem arises as the bottom ends of the hinge pins are recessed and permanently formed into the bottom hinge leaf brackets. When the bushings, through which these pins rotate wear out, there is no way in cost effectively repairing the hinge. When failure of the hinge pin or bushing occurs, the complete pillar hinge must be replaced, with a hefty price tag in parts and labor.

The object of this invention is to provide a cost effective, removable, and reusable hinge pin to replace the original, permanently formed pin of the OEM hinge assembly.

### BRIEF SUMMARY OF INVENTION

A vehicle door hinge assembly according to this invention has two hinge brackets, one for mounting to a door, and one for mounting to a body pillar of a vehicle. Each hinge bracket has a pair of spaced-apart legs. One hinge bracket is an outer hinge bracket, and the other is an inner hinge bracket. These two hinge brackets are hingedly mated together with hinge pins. Being an Autobody technician for fifteen years, I found it common to replace worn door bushings and pins on vehicle hinges. As the vehicle gets older, the, pins and bushings simply wear out from constant use, causing sheet metal mis-alignment.

The “MAGNUM HINGE PIN REPLACEMENT” is an improved hinge pin invention were the OEM hinge pins and bushings are removed and the “MAGNUM HINGE PIN REPLACEMENT” pins and aftermarket bushings are installed at a fraction of the cost of the entire pillar hinge. Prior to this invention the removal and replacement of the entire pillar hinge was the only repair method.

The “MAGNUM HINGE PIN REPLACEMENT” is to be considered an aftermarket hinge pin to repair door misalignment in GENERAL MOTORS/CHEVROLET CK1500/2500 series pickups.

### BRIEF DESCRIPTION OF THE DRAWINGS

Additional features and advantages will become apparent to those skilled in the art upon consideration of the following detailed description of a preferred embodiment exemplifying the best mode of carrying out the invention as presently perceived. The detailed description particularly refers to the accompanying figures in which:

FIG. 1 Fragmentary perspective view of a vehicle body assembly with invention pins inserted.

FIG. 2 Exploded view of FIG. 1

FIG. 3 Cross-section partial view of the door pillar hinge assembly with invention pins inserted.

FIG. 4 Gives numerical dimensions of the upper hinge pin.

FIG. 5 Gives numerical dimensions of the lower hinge pin.

### DETAILED DESCRIPTION OF DRAWINGS

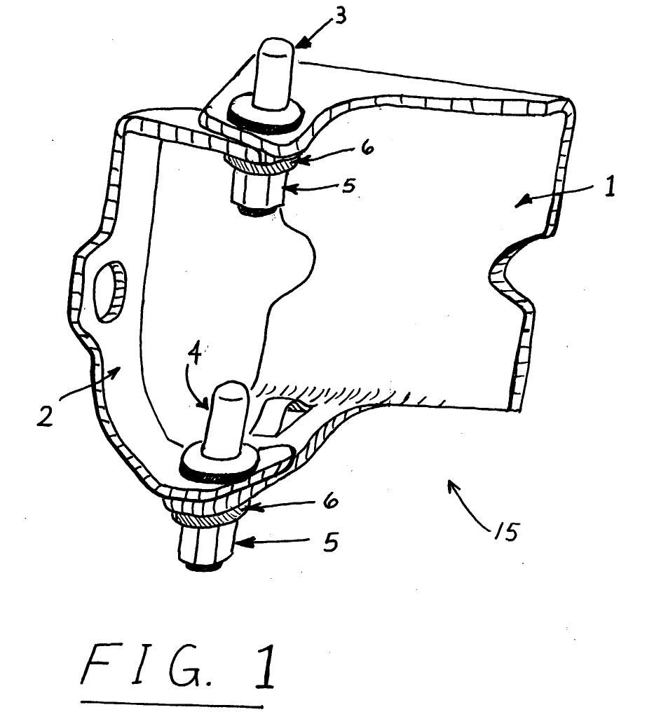

Referring to FIG. 1 a vehicle hinge assembly is shown. This particular assembly has two parts to it, labeled 1 and 2. They are operatively interconnected by two threaded pins, 3 and 4 which are held in place by a washer 6 and a self locking nut 5. Hinge assembly, 15, is solid welded to the vehicle pillar, readily to accept the bracket (not shown) which is attached to the door shell.

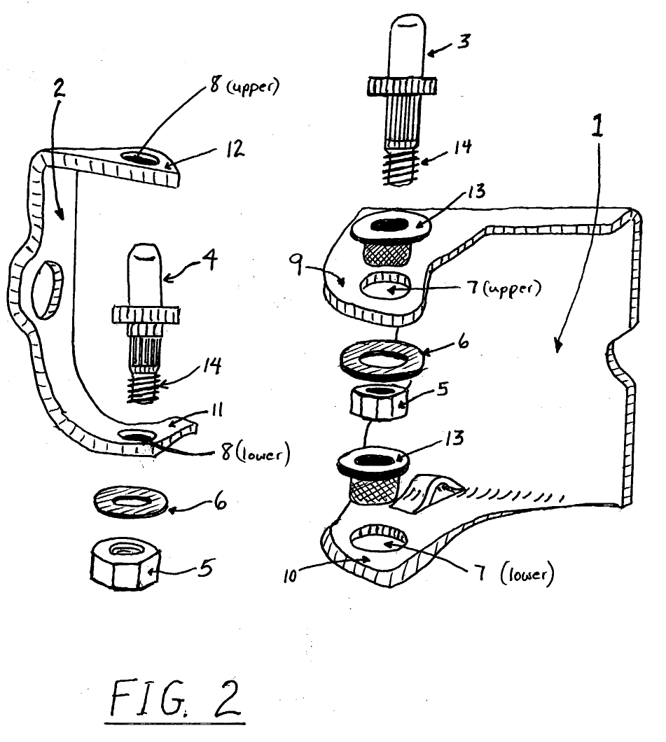

In referring to FIG. 2 pillar hinge part 1 has two vertically aligned holes, 7(upper) and 7(lower) formed into its legs 9 and 10. Suitable bushings 13 are installed into these holes. Pillar hinge 1 further includes a second U-SHAPED bracket 2 with vertically aligned perforated mounting holes 8(upper) and 8(lower) on the ends of its legs 11 and 12. The perforated legs 11 and 12 of hinge part 2 are aligned to the main pillar hinge 1 by two hinge pins 3 and 4. The respective pairs of legs 11 and 12 mount inside the former legs of hinge part 1 (9 and 10). The location of the pairs of holes 7 and 8 are now aligned for pin installation.

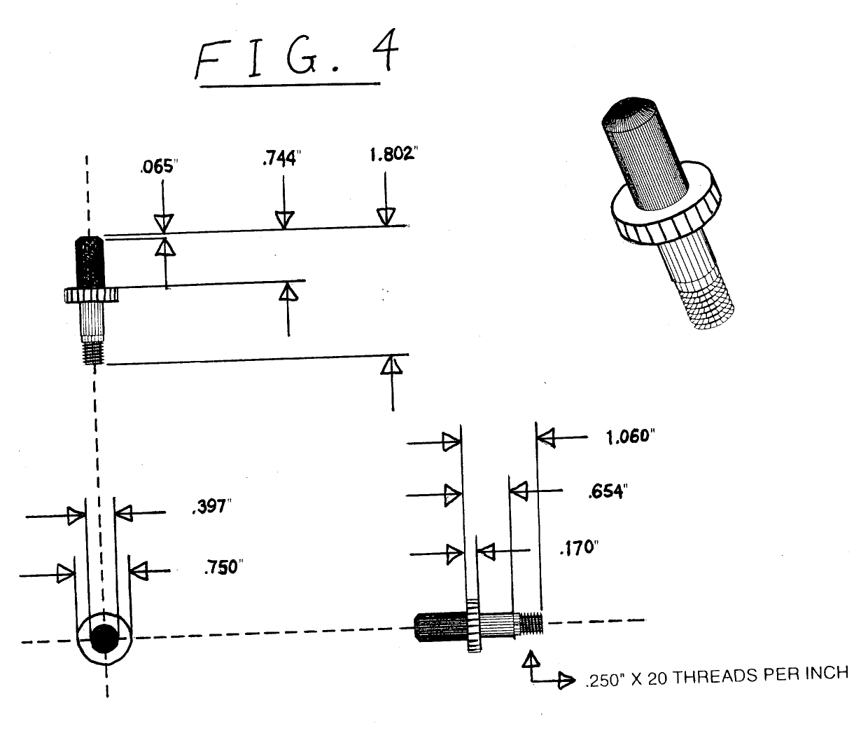

Once holes 7 and 8 are aligned, pin 3 extends downwardly through holes 7(,upper) and 8(upper) to maintain a pivotal, relatively tight butt relationship between main pillar hinge leg 9 and second bracket leg 12. The top pin has specific measurements pertaining to its fit into its respective holes, see FIG. 4 for top pin dimensions.

Once pin 3 is set through its respective holes, the threaded part of the pin is exposed on the bottom side of the bracket leg 12. A flat washer 6 and self locking nut 5 are installed onto the threads 1-4 and tightened with a tool (not shown) readily know in the automotive industry. The pin is pulled into place by tightening the nut.

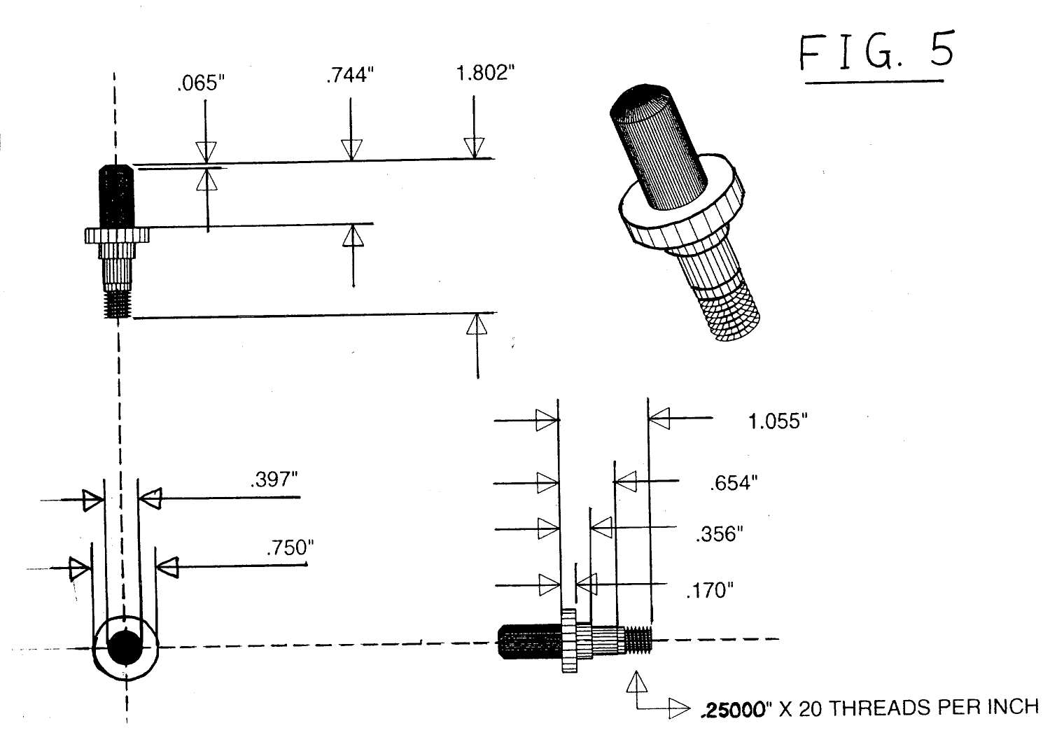

Lower pin 4 is then pushed downwardly through its aligned holes 8(lower) and 7(lower) respectively. Once in place, it too produces a pivotal, relatively tight butt relationship between legs 10 and 11. The bottom hinge pin 4 also has its own specific dimensions pertaining to its fit through holes 8(lower) and 7(lower). See FIG. 5 for lower pin dimensions.

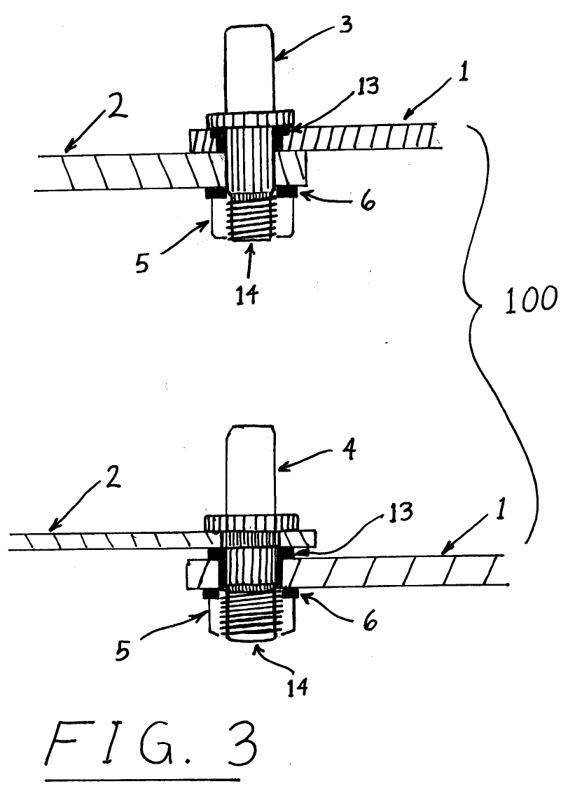

Once pin 4 is set through its respective holes, the threaded part of the pin is exposed on the bottom side of the bracket leg 10. A flat washer 6 and self locking nut 5 are installed onto the threads 14, with the same automotive tool as for pin 3. Pin 4 is pulled into place by tightening the nut. in the illustrative embodiment of FIG. 3, the hinge assembly 100 has the improved hinge pins installed.

Although this invention has been described in best detail with reference to certain preferred embodiments and specific measurements, variations and modifications exist within the scope and spirit of the invention as defined in the following claims.

What I claim as my invention is:

1. In a vehicle door hinge assembly there are two brackets with two legs per bracket. One bracket when aligned with the other gives unrestrained lateral movement. The improvement comprising of a threaded hinge pin with specific measurements to replace the original pin. This invention allows removal and replacement of the pin to install new bushings in which the pin rotates, thus realigning the body sheet metal without the removal and replacement of the entire pillar hinge assembly.

2. The vehicle door hinge assembly of claim #1 wherein newly designed vehicle hinge pins are precisely machined to accept OEM/Aftermarket replacement bushings.

3. A vehicle door hinge assembly of claim #2 wherein the new pin is then pulled and secured into place through its respective bracket holes by threads on the lower end of the pin, via a self locking nut and washer. This holds the pin secure and prevents the possibility of any pin movement during door operation.
